(19) United States
(12) Patent Application Publication
(10) Pub. No.: US 2005/0006357 A1
(43) Pub. Date: Jan. 13, 2005

(54) Process for transferring a photo image to a medium

(75) Inventor: F. Hayden Connor, Denver, CO (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: GFG, INC.

(21) Appl. No.: 10/616,221

(22) Filed: Jul. 10, 2003

(51) Int. Cl. B23K 26/36

(52) U.S. Cl. 219/121.69; 700/166

(57) ABSTRACT

The invention relates to a process for transferring a photo image to an article by first converting a photo image into an electronic format. The next step is to edit the photo image as needed using image editing software. After the photo image has been edited, if editing is needed, the photo image can then be converted into a format that compatible with a computer aided laser system. Following the appropriate formatting of the photo image, the photo image can then be modified via image editing software to produce a desired effect in the article. Finally, the photo image can be carved or etched into the article via the computer aided laser system. Thus, a process of the present invention can enhance the personal appeal and overall allure of an article such as a wood frame.

### BACKGROUND OF THE INVENTION

1. Field of the Invention

The present invention relates to a method or process of engraving materials using a laser. More particularly, the present invention relates to a process for transferring a photo image to a medium.

2. Description of the Prior Art

It is well known that lasers can develop sufficient power densities to vaporize certain materials. Lasers such as high-power carbon dioxide lasers can vaporize many materials such as wood, plastic and rubber, relatively efficiently. The use of the laser offers the potential of producing very intricate engravings in a variety of materials. In addition, it is well known to employ laser technology to create personalized memorabilia such as for example, picture frames, mantle clocks, trophies, and/or collectable items.

However, notwithstanding the foregoing, manufacturers of these personalized/collectable articles are constantly seeking new ways to package, market and sale these somewhat conventional articles. Accordingly, there is a need to develop a process that allows a consumer to uniquely personalize an article by carving or etching a personal photo image into at least a portion of the article thereby enhancing the overall allure of the article.

### SUMMARY OF THE INVENTION

It is an object of the present invention to provide a process for enhancing the overall allure of a conventional article by carving or etching a personalized photo image into a portion of the article via electronic software and a computerized laser system.

It is another object of the present invention to provide a process for enhancing the overall allure of a wood article by carving or etching a personalized photo image into a portion of the article via electronic software and a computerized laser system.

It is another object of the present invention to provide a process for enhancing the overall allure of a wood picture frame by carving or etching a personalized photo image into a portion of the picture frame via electronic software and a computerized laser system.

It is another object of the present invention to provide such a process for enhancing the overall allure of a article by carving or etching a personalized photo image into a portion of the article via electronic software and a computerized laser system and that allows an individual to determine the portion of the photo image to be etched onto the article.

These and other objects and advantages of the present invention are achieved by a process for transferring a photo image to an article by first converting a photo image into an electronic format. The next step is to edit the photo image as needed using image editing software. After the photo image has been edited, if editing is needed, the photo image can then be converted into a format that is compatible with a computer aided laser system. Following the appropriate formatting of the photo image, the photo image can then be modified via image editing software to produce a desired effect in the article. Finally, the photo image can be carved or etched into the article via the computer aided laser system. Thus, a process of the present invention can enhance the personal appeal and overall allure of an article such as a wood frame.

### BRIEF DESCRIPTION OF THE DRAWINGS

Other and further objects, advantages and features of the present invention will be understood by reference to the following specification in conjunction with the accompanying drawings, in which like reference characters denote like elements of structure.

FIG. 1 is a schematic diagram reflecting a process in accordance with an illustrative embodiment of the present invention;

FIG. 2 is a flow diagram of the process in accordance with an illustrative embodiment of the present invention; and

FIG. 3 is an illustrative embodiment of a article enhanced by in accordance with the process reflected in FIG. 1.

### DETAILED DESCRIPTION OF THE INVENTION

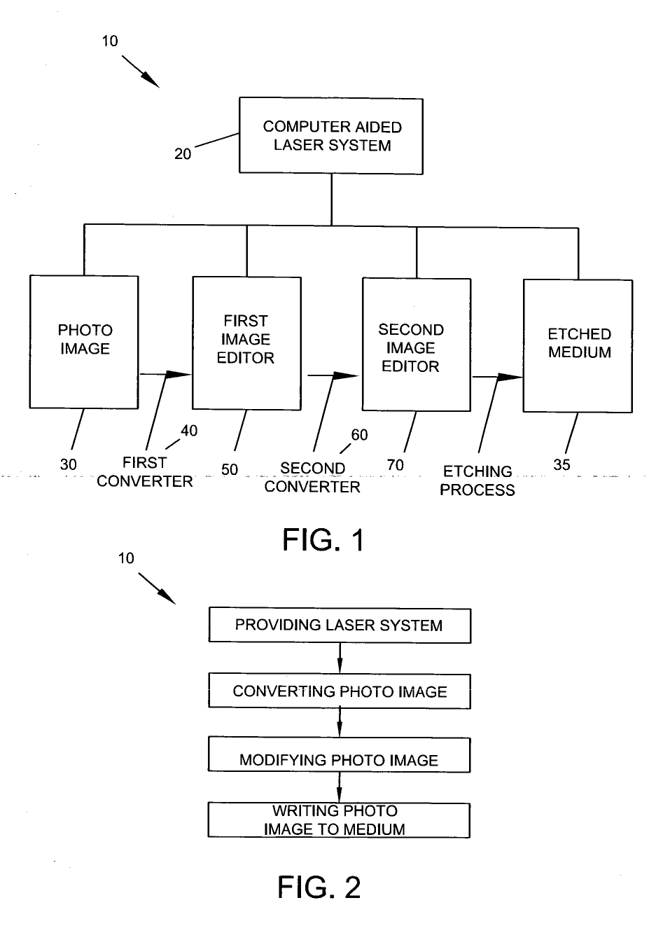

Referring to the drawings and, in particular to FIG. 1, there is shown an illustrative embodiment of a process for enhancing the personal appeal and/or overall allure of an article such as for example, a wood frame. The process generally represented by reference numeral 10.

Preferably, process 10 employs a computer aided laser system 20. Laser system 20 can preferably be of any known type suitable for custom carving or etching a variety of different articles.

Process 10 preferably uses a first converter 40, such as for example a scanner, to convert a hard copy image 30 such as a photograph into a digital or an electronic format. Other means for converting a hard copy image 30 may also be used and are within the scope of the present invention.

Process 10 preferably employs a first image editor 50. First image editor 50 can be any software that allows a user to adjust the contrast, brightness, intensity and/or any other of a variety of visual effects in image 30. An example of such software is Corel Photo Paint™. Other software packages are readily available and may also be used in association with process 10. Preferably, first image editor 50 will enable a user to isolate those portions of image 30 that are of interest. Also, first image editor 50 preferably is capable of converting image 30 into a grayscale image in the range of about 8-bits.

Process 10 preferably uses a second converter 60 to convert the grayscale of image 30 into a format that is compatible with laser system 20. Second converter 60 can be any software suitable for formatting various images into a format consistent with that of laser system 20. For example, PhotoGrav™ is a software program capable of accomplishing this type of task in addition to others. It is noted that other currently available software programs may also be used and are within the scope of the present invention.

Process 10 preferably also uses a second image editor 70 to enable a user to customize the outline or cut-line to follow the contour of the subject (e.g., person, animal and/or scenery) of interest in image 30. Second image editor 70 can be any software suitable for outlining or identifying that portion of image 30 to be transferred or etched on an article. Second image editor 70 should also allow a user to add text as desired such that the text is incorporated into image 30 etched on an article. For example, Corel Draw™ is a software program that can be used to accomplishing these and other tasks. It is noted that other currently available software programs may also be used and are within the scope of the present invention.

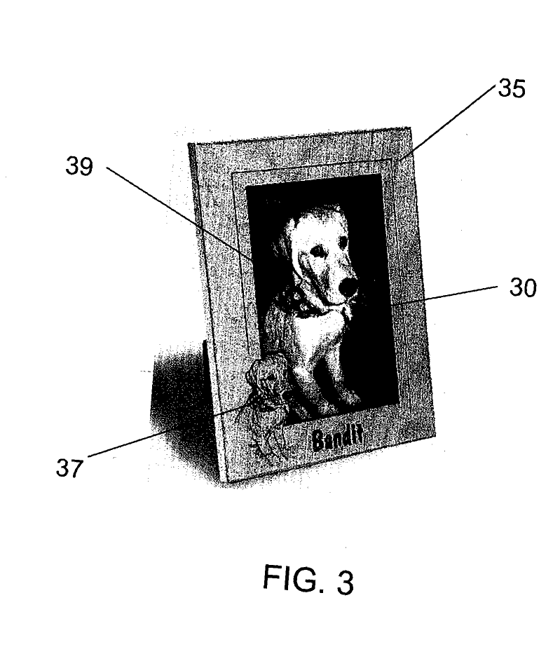

Referring to FIGS. 2 and 3, having described some of the preferred characteristics of the illustrative embodiment, the process or method for transferring a photo image to a medium, preferably includes at least the following steps. First converting a photo image 30, such as that shown in FIG. 3, into an electronic format via first converter 40. The next step is to edit the photo image as needed using first image editor 50. After the photo image has been edited as desired, the photo image can then be converted, via second converter 60 into a format compatible with computer aided laser system 20. Following the appropriate formatting of the photo image, the photo image can then be modified, via second image editor 70, to produce a desired appearance or effect in an article, such as a wood picture frame 35 as shown in FIG. 3. Finally, the photo image can be carved or etched into an article via computer aided laser system 20. Preferably, at least in the case of picture frame 35, the photo image is etched on a protruding portion 37 of the frame. Preferably, protruding portion 37 overlaps at least a portion of a picture display area 39. Thus, the process of the present invention enhances the personal appeal and overall allure of an article.

The present invention having been thus described with particular reference to the preferred forms thereof, it will be obvious that various changes and modifications may be made therein without departing from the spirit and scope of the present invention as defined herein.

1. A process for transferring a photo image to a medium comprising the steps of:
converting a photo image into an electronic format;
editing said photo image via a first electronic editor;
converting said photo image via a second electronic editor into a format compatible with a computer aided laser system;
importing said photo image into a third electronic editor to create a desired cut line; and
etching said photo image to a medium via said computer aided laser system.

2. The process of claim 1, wherein said medium is a wood.

3. The process of claim 2, wherein said wood is in the form of a picture frame.

4. The process of claim 3, wherein said picture frame has a protruding portion on which the photo image is etched.

5. The process of claim 4, wherein said protruding portion overlaps at least a portion of the photograph display area associated with said picture frame.

6. The process of claim 1, wherein said photo image is converted into electronic format by scanning said photo image into a computer.

7. The process of claim 1, wherein said first electronic editor enables a user to adjust the contrast, brightness and/or intensity of said photo image as appropriate to improve the quality thereof.

8. The process of claim 1, wherein during said editing step said photo image is converted into an 8-bit grayscale.

9. The process of claim 8, wherein said second electronic editor converts said grayscale to a format compatible with said computer aided laser system.

10. The process of claim 1, wherein said third electronic editor enables a user to add text to said photo image.

11. The process of claim 1, wherein said cut line coincides with features reflected in said photo image.

12. A process for etching a medium comprising the steps of:
providing a computer aided laser system;
converting a photo image into an electronic format compatible with said computer aided laser system;
modifying said photo image via image editing software to obtain a desired effect; and
writing said photo image to a medium via said computer aided laser system.

13. The process of claim 12, wherein said medium is a wood.

14. The process of claim 13, wherein said wood is in the form of a picture frame.

15. The process of claim 14, wherein said picture frame has a protruding portion on which the photo image is etched.

16. The process of claim 15, wherein said protruding portion overlaps at least a portion of the photograph display area associated with said picture frame.

17. The process of claim 12, wherein said third electronic editor enables a user to add text to said photo image.

18. The process of claim 12, wherein said step of modifying said photo image includes creating a cut line that coincides with one or more features reflected in said photo image.

19. A picture frame, comprising:
an outer border having one or more elements forming a picture display area, said outer border surrounding said picture display area; and
an protruding portion associated with one or more of said elements of said outer border, said protruding portion overlapping at least a portion of said picture display area,
wherein said protruding portion has an image etched thereon via the method of claim 12, said image being substantially similar to the picture in said picture display area.

20. The picture frame of claim 19, wherein said etched image is personalized to the preferences of a consumer.
